(19) United States
(12) Patent Application Publication
(10) Pub. No.: US 2004/0066796 A1
(43) Pub. Date: Apr. 8, 2004

(54) Radio base system, transmission timing control method, and transmission timing control program

(76) Inventors: Seigo Nakao, Gifu-shi Gifu (JP); Takeo Miyata, Anpachi-gun Gifu (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/450,714

(22) PCT Filed: Dec. 21, 2001
(86) PCT No.: PCT/JP01/11312

(30) Foreign Application Priority Data
Dec. 27, 2000 (JP) 2000-397365

(51) Int. Cl. H04L 12/43

(52) U.S. Cl. 370/458; 370/395.4

(57) ABSTRACT

The radio base station system shifts and directly allocates the transmission timing for a new user from a normal transmission timing to an optimal transmission timing position within the slot to which a mobile terminal device of the new user is about to connect. Thus, it becomes unnecessary to narrow in advance the transmission timings for users already connected to the relevant slot.

### TECHNICAL FIELD

The present invention relates to radio base station systems, transmission timing control methods and transmission timing control programs, and more particularly to a radio base station system permitting path multiple connection of a plurality of mobile terminal devices in a mobile communication system, and a transmission timing control method and a transmission timing control program for providing such a radio base station system with an appropriate reception timing from a mobile terminal device as well as providing the mobile terminal device with an appropriate reception timing from the radio base station system.

### BACKGROUND ART

In recent years, in rapidly developing mobile communication systems (e.g., the Personal Handyphone System: hereinafter, “PHS”), a path division multiple access (PDMA) system has been proposed to enhance utilization efficiency of radio frequencies, in which a single time slot of a single frequency is divided spatially to allow mobile terminal devices of a plurality of users to establish path multiple connection to a radio base station system. In this PDMA system, signals from respective users' mobile terminal devices are separated and extracted by well-known adaptive array processing.

In a mobile communication system according to such a PDMA system, a reception timing at which a signal transmitted from a mobile terminal device arrives at a radio base station (hereinafter, also referred to as a “synchronous position”) varies due to a variety of factors, such as variation of the distance between the terminal device and the base station because of movement of the terminal device, variation of radio wave propagation path characteristics and others.

In the mobile communication system of the PDMA system, when mobile terminal devices of a plurality of users have established path multiple connection with one and the same time slot, the reception timings of signals from the respective mobile terminal devices would vary due to the above-described reasons, and they may become too close to each other or even become reversed in temporal relationship with each other.

If the reception timings become too close to each other, correlation between the signals received from the plurality of mobile terminal devices would become too high. This leads to degradation in precision of signal extraction for each user during the adaptive array processing and, consequently, impaired speech characteristics for each user.

Further, in the PHS, a signal received from a respective mobile terminal device includes a reference signal section for each frame that is formed of a known bit train common to all the users. If the reception timings of the signals from the mobile terminal devices of a plurality of users match with each other, the reference signal sections of the reception signals would overlap one another. This hinders identification and separation of the users from each other, thereby causing interference (so-called “swap”) between the users.

Accordingly, there is a need to control the reception timings from mobile terminal devices of a plurality of users having established path multiple connection with one and the same time slot, to ensure that the reception timings of the relevant mobile terminal devices do not become too close to each other or reversed in time with each other.

An effective way to control the reception timings from the mobile terminal devices is to control transmission timings from the radio base station system to the mobile terminal devices.

It is now explained why the control of the transmission timing for a respective user enables the control of the reception timing of each user.

In a mobile communication system like PHS, for example, it is specified by the standard, regarding signal transmission/reception timings between a radio base station system and mobile terminal devices, that a mobile terminal device transmits a signal to the radio base station system a predetermined time after reception of a signal from the radio base station system.

That is, if the signal transmission timings to respective users are shifted in the radio base station system, the signal reception timings of the corresponding mobile terminal devices are shifted accordingly. This in turn shifts the signal transmission timings from the respective mobile terminal devices to the radio base station system.

As a result, in the radio base station system, the signal reception timings from the respective mobile terminal devices are shifted.

Thus, by controlling the signal transmission timings to respective mobile terminal devices in the radio base station system, the signal reception timings from the relevant mobile terminal devices can be controlled indirectly in the radio base station system. Even a sufficient interval between the reception timings can be guaranteed.

In a mobile communication system of the PDMA system, however, such an interval between the transmission timings in a time slot inevitably narrows as the number of users having established path multiple connection with the relevant slot increases, or a degree of path multiplexing increases. This might result in the reception timings too close to each other or reversed in time with each other. In such a case, speech characteristics would be degraded, and interference would occur between the users, as described above.

It is thus conceivable, for example, to prohibit connection of a new user to a slot with a high degree of path multiplexing, and, in a slot of a relatively low degree of path multiplexing, to secure a position for allocation to a transmission timing for a new user so as to allow the new user to connect to the slot.

That is, since a transmission timing for a new user is generally set at a leading position of a slot, it is necessary to shift the transmission timing for any user already connected to the relevant slot so as to secure the leading transmission timing position for the new user. Such shifting of the transmission timing for the already connected user cannot be performed so rapidly, from the consideration of tracking capability of the mobile terminal device.

In other words, it is impossible to shift the transmission timing for any connected user to secure the transmission timing position for a new user in an instant upon receipt of a connection request from the new user. Thus, it is necessary to shift (narrow) the transmission timing(s) for the already connected user(s) in advance of the receipt of the connection request from a new user to secure the transmission timing position therefor.

In such a case, however, it is unclear whether or when the connection request arrives from a new user. Even if there is such a request, it may take a long period of time before the receipt of the request.

It is undesirable to maintain the state with the transmission timing(s) for the already connected user(s) narrowed under the situation that it is uncertain when and whether a connection request from a new user arrives, from the standpoint of property degradation.

Accordingly, an object of the present invention is to provide a radio base station system, a transmission timing control method and a transmission timing control program in which a transmission timing for a new user is shifted and directly allocated to a currently optimal transmission timing in a time slot, without narrowing a transmission timing interval for mobile terminal devices of the users already connected to the same slot, to suppress degradation of speech characteristics and interference between the users.

### DISCLOSURE OF THE INVENTION

According to the present invention, the radio base station system permitting path multiple connection of a plurality of mobile terminal devices and transmitting/receiving signals to/from the plurality of mobile terminal devices in units of a plurality of slots includes measuring means and transmission timing control means. The measuring means measures the number of other mobile terminal devices previously connected to one of the plurality of slots to which a new mobile terminal device is about to connect, and transmission timing positions for the other mobile terminal devices within the slot. The transmission timing control means, when a result of measurement of the measuring means shows that there is not any other mobile terminal device connected to the slot, allocates a transmission timing for the new mobile terminal device to a leading timing position in the slot, and, when the result shows that there is at least one such other mobile terminal device already connected to the slot, allocates the transmission timing for the new mobile terminal device to a transmission timing position that is the farthest from the transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the transmission timing control means allocates the transmission timing for the new mobile terminal device to the transmission timing position that is the closest to the leading timing position, among the plurality of transmission timing positions.

Still preferably, in the case where the total number of the mobile terminal devices connected to the plurality of slots satisfies a predetermined condition, the transmission timing control means moves in advance the transmission timing position for the other mobile terminal device to secure a timing position to be allocated to the transmission timing for the new mobile terminal device when the number of the other mobile terminal devices connected to the slot is a first predetermined number, and prohibits connection of the new mobile terminal device when the predetermined condition is unsatisfied, with the timing position to be allocated to the transmission timing for the new mobile terminal device being unsecured.

Still preferably, the transmission timing control means prohibits connection of the new mobile terminal device when the number of the other mobile terminal devices connected to the slot is a second predetermined number.

Still preferably, when any of the mobile terminal devices connected to the slot is disconnected, the transmission timing control means controls the transmission timing for the mobile terminal device still connected to the slot such that the transmission timing for the remaining mobile terminal device is moved to a predetermined transmission timing position.

Still preferably, the transmission timing control means moves a transmission timing of a synchronous burst transmitted to the new mobile terminal device during processing of a traffic channel, thereby moving the transmission timing for the new mobile terminal device.

According to another aspect of the present invention, the radio base station system permitting path multiple connection of a plurality of mobile terminal devices and transmitting/receiving signals to/from the plurality of mobile terminal devices in units of a plurality of slots includes first measuring means, second measuring means and transmission timing control means. The first measuring means measures, for a mobile terminal device attempting to switch a traffic channel, a transmission timing position in a slot to which the mobile terminal device has been connected before the switching. The second measuring means measures, for one of the plurality of slots to which the mobile terminal device attempting to switch the traffic channel is about to connect, the number of other mobile terminal devices previously connected to the slot and transmission timing positions for the other mobile terminal devices in the slot. The transmission timing control means, when a result of measurement of the second measuring means shows that there is not any other mobile terminal device connected to the slot, allocates a transmission timing for the mobile terminal device attempting to switch the traffic channel to a transmission timing position within the slot that corresponds to the transmission timing position in the slot to which the mobile terminal device has been connected before the switching measured by the first measuring means, and, when there is at least one such other mobile terminal device already connected to the slot, allocates the transmission timing for the mobile terminal device attempting to switch the traffic channel to a transmission timing position that is the farthest from the transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the transmission timing control means allocates the transmission timing for the mobile terminal device attempting to switch the traffic channel to the transmission timing position that is the closest to the transmission timing position in the slot to which the mobile terminal device has been connected before the switching, among the plurality of transmission timing positions.

Still preferably, in the case where the total number of the mobile terminal devices connected to the plurality of slots satisfies a predetermined condition, when the number of the other mobile terminal devices connected to the slot is a first predetermined number, the transmission timing control means moves in advance the transmission timing position for the other mobile terminal device to secure a timing position to be allocated to the transmission timing for the mobile terminal device attempting to switch the traffic channel, and, when the predetermined condition is unsatisfied, with the timing position to be allocated to the transmission timing for the mobile terminal device attempting to switch the traffic channel being unsecured, prohibits connection of the mobile terminal device attempting to switch the traffic channel.

Still preferably, when the number of the other mobile terminal devices connected to the slot is a second predetermined number, the transmission timing control means prohibits connection of the mobile terminal device attempting to switch the traffic channel.

Still preferably, when any of the mobile terminal devices connected to the slot is disconnected, the transmission timing control means controls the transmission timing for the mobile terminal device still connected to the slot such that the transmission timing for the remaining mobile terminal device is moved to a predetermined transmission timing position.

Still preferably, the transmission timing control means moves a transmission timing of a synchronous burst transmitted to the mobile terminal device attempting to switch the traffic channel during processing of a traffic channel, to thereby move the transmission timing for the mobile terminal device attempting to switch the traffic channel.

According to a further aspect of the present invention, the transmission timing control method in a radio base station system permitting path multiple connection of a plurality of mobile terminal devices and transmitting/receiving signals to/from said plurality of mobile terminal devices in units of a plurality of slots includes the step of measuring the number of other mobile terminal devices previously connected to one of the plurality of slots to which a new mobile terminal device is about to connect, and transmission timing positions for the other mobile terminal devices within the slot, and the step of, when there is not any other mobile terminal device connected to the slot as a result of measurement of the measuring step, allocating a transmission timing for the new mobile terminal device to a leading timing position in the slot, and, when there is at least one such other mobile terminal device already connected to the slot, allocating the transmission timing for the new mobile terminal device to a transmission timing position that is the farthest from a transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the step of controlling the transmission timing includes the step of allocating the transmission timing for the new mobile terminal device to the transmission timing position that is the closest to the leading timing position, among the plurality of transmission timing positions.

Still preferably, in the case where the total number of the mobile terminal devices connected to the plurality of slots satisfies a predetermined condition, the step of controlling the transmission timing includes the step of, when the number of the other mobile terminal devices connected to the slot is a first predetermined number, moving in advance the transmission timing position for the other mobile terminal device to secure a timing position to be allocated to the transmission timing for the new mobile terminal device, and, when the predetermined condition is unsatisfied, with the timing position to be allocated to the transmission timing for the new mobile terminal device being unsecured, prohibiting connection of the new mobile terminal device.

Still preferably, the step of controlling the transmission timing includes the step of prohibiting connection of the new mobile terminal device when the number of the other mobile terminal devices connected to the slot is a second predetermined number.

Still preferably, the step of controlling the transmission timing includes the step of, when any of the mobile terminal devices connected to the slot is disconnected, controlling the transmission timing for the mobile terminal device still connected to the slot such that the transmission timing for the remaining mobile terminal device is moved to a predetermined transmission timing position.

Still preferably, the step of controlling the transmission timing includes the step of moving a transmission timing of a synchronous burst transmitted to the new mobile terminal device during processing of a traffic channel to thereby move the transmission timing for the new mobile terminal device.

According to a still further aspect of the present invention, the transmission timing control method in a radio base station system permitting path multiple connection of a plurality of mobile terminal devices and transmitting/receiving signals to/from the plurality of mobile terminal devices in units of a plurality of slots includes the step of measuring, for a mobile terminal device attempting to switch a traffic channel, a transmission timing position in a slot to which the mobile terminal device has been connected before the switching, the step of measuring, for one of the plurality of slots to which the mobile terminal device attempting to switch the traffic channel is about to connect, the number of other mobile terminal devices previously connected to the slot and transmission timing positions for the other mobile terminal devices in the slot, and the step of, when there is not any other mobile terminal device connected to the slot as a result of the measurement, allocating a transmission timing for the mobile terminal device attempting to switch the traffic channel to a transmission timing position within the slot that corresponds to the measured transmission timing position in the slot to which the relevant mobile terminal device has been connected before the switching, and, when there is at least one such other mobile terminal device already connected to the slot, allocating the transmission timing for the mobile terminal device attempting to switch the traffic channel to a transmission timing position that is the farthest from the transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the step of controlling the transmission timing includes the step of allocating the transmission timing for the mobile terminal device attempting to switch the traffic channel to the transmission timing position that is the closest to the transmission timing position in the slot to which the mobile terminal device has been connected before the switching, among the plurality of transmission timing positions.

Still preferably, in the case where the total number of the mobile terminal devices connected to the plurality of slots satisfies a predetermined condition, the step of controlling the transmission timing includes the step of, when the number of the other mobile terminal devices connected to the slot is a first predetermined number, moving in advance the transmission timing position for the other mobile terminal device to secure a transmission timing position to be allocated to the transmission timing for the mobile terminal device attempting to switch the traffic channel, and, when the predetermined condition is unsatisfied, with the transmission timing position to be allocated to the transmission timing for the mobile terminal device attempting to switch the traffic channel being unsecured, prohibiting connection of the mobile terminal device attempting to switch the traffic channel.

Still preferably, the step of controlling the transmission timing includes the step of prohibiting connection of the mobile terminal device attempting to switch the traffic channel when the number of the other mobile terminal devices connected to the slot is a second predetermined number.

Still preferably, the step of controlling the transmission timing includes the step of, when any of the mobile terminal devices connected to the slot is disconnected, controlling the transmission timing for the mobile terminal device still connected to the slot such that the transmission timing for the remaining mobile terminal device is moved to a predetermined transmission timing position.

Still preferably, the step of controlling the transmission timing includes the step of moving a transmission timing of a synchronous burst transmitted to the mobile terminal device attempting to switch the traffic channel during processing of a traffic channel, thereby moving the transmission timing for the mobile terminal device attempting to switch the traffic channel.

According to yet another aspect of the present invention, the transmission timing control program in a radio base station system permitting path multiple connection of a plurality of mobile terminal devices and transmitting/receiving signals to/from said plurality of mobile terminal devices in units of a plurality of slots makes a computer carry out the step of measuring the number of other mobile terminal devices previously connected to one of the plurality of slots to which a new mobile terminal device is about to connect, and transmission timing positions for the other mobile terminal devices within the slot, and the step of, when there is not any other mobile terminal device connected to the slot as a result of measurement of the measuring step, allocating a transmission timing for the new mobile terminal device to a leading timing position in the slot, and, when there is at least one such other mobile terminal device already connected to the slot, allocating the transmission timing for the new mobile terminal device to a transmission timing position that is the farthest from a transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the step of controlling the transmission timing includes the step of allocating the transmission timing for the new mobile terminal device to the transmission timing position that is the closest to the leading timing position, among the plurality of transmission timing positions.

Still preferably, in the case where the total number of the mobile terminal devices connected to the plurality of slots satisfies a predetermined condition, the step of controlling the transmission timing includes the step of moving in advance the transmission timing position for the other mobile terminal device to secure a timing position to be allocated to the transmission timing for the new mobile terminal device when the number of the other mobile terminal devices connected to the slot is a first predetermined number, and prohibiting connection of the new mobile terminal device when the predetermined condition is unsatisfied, with the timing position to be allocated to the transmission timing for the new mobile terminal device being unsecured.

Still preferably, the step of controlling the transmission timing includes the step of prohibiting connection of the new mobile terminal device when the number of the other mobile terminal devices connected to the slot is a second predetermined number.

Still preferably, the step of controlling the transmission timing includes the step of, when any of the mobile terminal devices connected to the slot is disconnected, controlling the transmission timing for the mobile terminal device still connected to the slot such that the transmission timing for the remaining mobile terminal device is moved to a predetermined transmission timing position.

Still preferably, the step of controlling the transmission timing includes the step of moving a transmission timing of a synchronous burst transmitted to the new mobile terminal device during processing of a traffic channel to thereby move the transmission timing for the new mobile terminal device.

According to a still further aspect of the present invention, the transmission timing control program in a radio base station system permitting path multiple connection of a plurality of mobile terminal devices and transmitting/receiving signals to/from said plurality of mobile terminal devices in units of a plurality of slots makes a computer carry out the step of measuring, for a mobile terminal device attempting to switch a traffic channel, a transmission timing position in a slot to which the mobile terminal device has been connected before the switching, the step of measuring, for one of the plurality of slots to which the mobile terminal device attempting to switch the traffic channel is about to connect, the number of other mobile terminal devices previously connected to the slot and transmission timing positions for the other mobile terminal devices in the slot, and the step of, when there is not any other mobile terminal device connected to the slot as a result of the measurement, allocating a transmission timing for the mobile terminal device attempting to switch the traffic channel to a transmission timing position within the slot that corresponds to the measured transmission timing position in the slot to which the mobile terminal device has been connected before the switching, and, when there is at least one such other mobile terminal device already connected to the slot, allocating the transmission timing for the mobile terminal device attempting to switch the traffic channel to a transmission timing position that is the farthest from the transmission timing position for the connected other mobile terminal device, without moving the transmission timing position for the connected other mobile terminal device.

Preferably, when there are a plurality of transmission timing positions that are the farthest from the transmission timing position for the connected other mobile terminal device, the step of controlling the transmission timing includes the step of allocating the transmission timing for the mobile terminal device attempting to switch the traffic channel to the transmission timing position that is the closest to the transmission timing position in the slot to which the mobile terminal device has been connected before the switching, among the plurality of transmission timing positions.

Still preferably, in the case where the total number of the mobile terminal devices connected to the plurality of slots satisfies a predetermined condition, the step of controlling the transmission timing includes the step of, when the number of the other mobile terminal devices connected to the slot is a first predetermined number, moving in advance the transmission timing position for the other mobile terminal device to secure a transmission timing position to be allocated to the transmission timing for the mobile terminal device attempting to switch the traffic channel, and, when the predetermined condition is unsatisfied, with the transmission timing position to be allocated to the transmission timing for the mobile terminal device attempting to switch the traffic channel being unsecured, prohibiting connection of the mobile terminal device attempting to switch the traffic channel.

Still preferably, the step of controlling the transmission timing includes the step of prohibiting connection of the mobile terminal device attempting to switch the traffic channel when the number of the other mobile terminal devices connected to the slot is a second predetermined number.

Still preferably, the step of controlling the transmission timing includes the step of, when any of the mobile terminal devices connected to the slot is disconnected, controlling the transmission timing for the mobile terminal device still connected to the slot such that the transmission timing for the remaining mobile terminal device is moved to a predetermined transmission timing position.

Still preferably, the step of controlling the transmission timing includes the step of moving a transmission timing of a synchronous burst transmitted to the mobile terminal device attempting to switch the traffic channel during processing of a traffic channel, thereby moving the transmission timing for the mobile terminal device attempting to switch the traffic channel.

As such, according to the present invention, in a time slot to which a new user is about to connect, a transmission timing for the new user is shifted and directly allocated from a normal transmission timing to an optimal transmission timing position in the slot. Thus, it becomes unnecessary to narrow in advance an interval between the transmission timings for users already connected to the same time slot, and degradation of speech characteristics and interference between the users can be suppressed.

### BRIEF DESCRIPTION OF THE DRAWINGS

FIG. 1 is a functional block diagram showing an entire configuration of a radio base station system according to the present invention.

FIG. 2 shows an allocation procedure of a transmission timing for a new user according to the present invention.

FIG. 3 is a flow chart illustrating basic processing of a transmission timing control method according to a first embodiment of the present invention.

FIG. 4 shows an exemplary reference table described in conjunction with step S2 of FIG. 3.

FIG. 5 schematically shows a procedure of preparing a 4-multiplexed condition in a 3-multiplexed condition.

FIG. 6 schematically shows arrangement of normal transmission timings with a decreased number of users.

FIG. 7 is a flow chart illustrating basic processing of the transmission timing control method according to a second embodiment of the present invention.

FIG. 8 shows an exemplary reference table described in conjunction with step S13 in FIG. 7.

### BEST MODES FOR CARRYING OUT THE INVENTION

Hereinafter, embodiments of the present invention will be described in detail with reference to the drawings. In the drawings, like or corresponding portions are denoted by like reference characters, and description thereof will not be repeated.

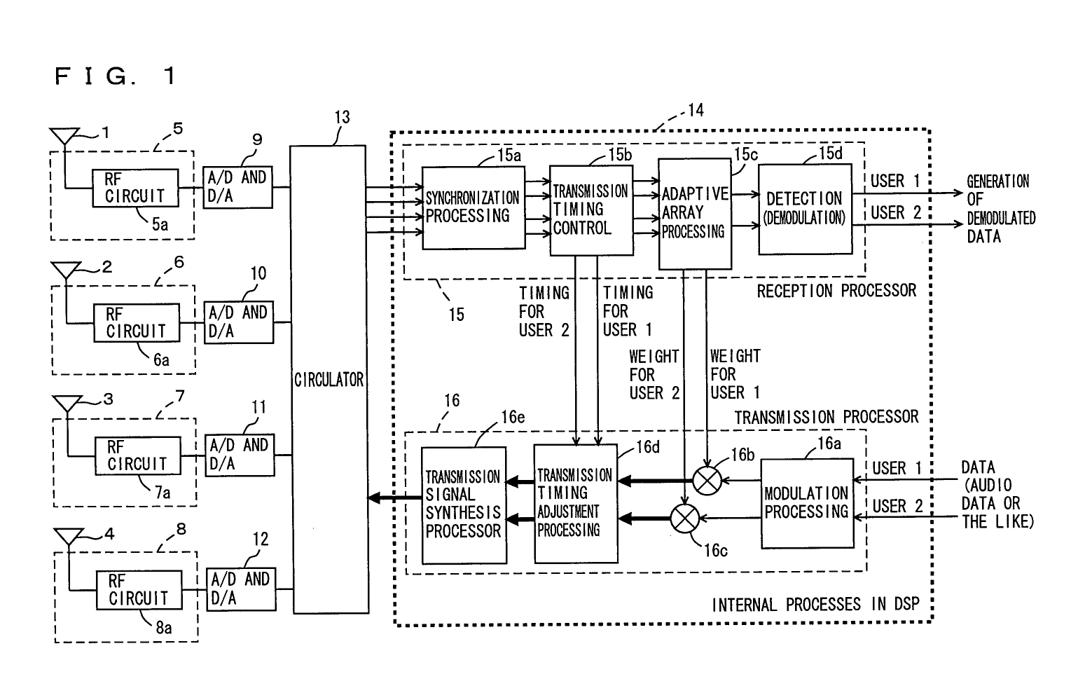

FIG. 1 is a functional block diagram showing the entire configuration of the radio base station system according to the present invention.

Referring to FIG. 1, signals from mobile terminal devices of a plurality of users received via a plurality of, e.g., four, antennas 1, 2, 3, 4 of the radio base station system are subjected to reception processing at respective RF circuits 5a, 6a, 7a, 8a of corresponding transmission/reception circuits 5, 6, 7, 8, and then converted into digital signals by A/D and D/A converters 9, 10, 11, 12.

The four streams of signals received via the respective antennas and converted to the digital signals are applied to a digital signal processor (DSP) 14 via a circulator 13. The inside of the DSP delimited with a broken line 14 is shown as a functional block diagram illustrating processes being carried out by the DSP utilizing software.

The four streams of reception signals provided to DSP 14 via circulator 13 are applied to a synchronization processing unit 15a in a reception processor 15. Synchronization processing unit 15a employs a well-known synchronous position estimating method to perform high-precision estimation of reception timings of the respective reception signals from the plurality of users (in this example, user 1 and user 2) who have established path multiple connection with the relevant radio base station system.

A transmission timing control unit 15b generates transmission timing control signals for respective users based on the reception timings estimated for the corresponding users. It carries out transmission tiling control in accordance with the present invention, which will be described later in detail.

Next, the reception signals undergo well-known adaptive array processing by an adaptive array processing unit 15c, and the reception signals from user 1 and user 2 are separated and extracted using weights calculated for user 1 and user 2.

The signals separated and extracted for the respective users are demodulated by a detector unit 15d, and are output from DSP 14 as demodulated data of user 1 and user 2.

Data (audio data or the like) to be transmitted to users 1 and 2 are applied to a modulation processing unit 16a of a transmission processor 16 in DSP 14. The data of users 1 and 2 modulated by modulation processing unit 16a are provided to respective one inputs of corresponding multipliers 16b, 16c.

Multipliers 16b, 16c have the respective other inputs receiving the weights of corresponding users 1, 2 calculated by adaptive array processing unit 15c, and transmission directivities of the data of users 1 and 2 are determined.

The outputs of multipliers 16b, 16c are applied to a transmission timing adjustment processing unit 16d. Transmission timing adjustment processing unit 16d, as will be described later, adjusts transmission timings of the data of users 1 and 2 based on the transmission timing control signals for users 1 and 2 received from transmission timing control unit 15b.

A transmission signal synthesis processing unit 16e synthesizes transmission signals for users 1 and 2 and converts them to four streams of transmission signals, shown by one arrow in the drawing, which are then distributed to A/D and D/A converters 9, 10, 11, 12 via circulator 13. The four streams of transmission signals converted to analog signals by A/D and D/A converters 9, 10, 11, 12 are subjected to transmission processing by respective RF circuits 5a, 6a, 7a, 8a of corresponding transmission/reception circuits 5, 6, 7, 8, and then forwarded via corresponding antennas 1, 2, 3, 4 to the mobile terminal devices.

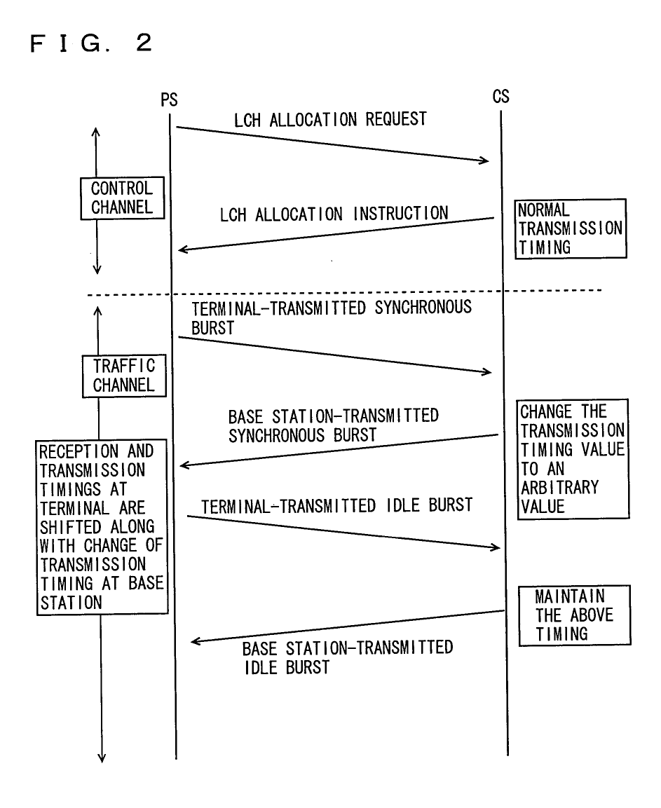

FIG. 2 shows a procedure for allocation of a transmission timing for a new user according to the present invention. In the PDMA-type mobile communication system, for example, an up link (from mobile terminal device to radio base station system) and a down link (from radio base station system to mobile terminal device) transmit data in units of 4 slots alternately in time series. The up link and the down link both have the same format.

Specifically, a control channel (hereinafter, CCH) signal is allocated to a leading slot 1, and an information channel (Traffic Channel: hereinafter, TCH) signal is allocated to the succeeding three slots 2-4. The control channel signal CCH is used for activating the information channel TCH to establish an information (traffic) channel.

A connection request from a mobile terminal device of a new user starts at a processing stage of control channel CCH, with issuance of an allocation request of a link channel (LCH) from the mobile terminal device (Personal Station: PS) to the radio base station system (Cell Station: CS).

CS generally has an absolute reference timing of signal transmission/reception with respect to PS for each kind of channels.

CS in receipt of the LCH allocation request calculates a time difference between the actual reception timing of the LCH allocation request and the corresponding absolute reference timing, and transmits to PS an LCH allocation instruction at a transmission timing that is shifted from the absolute reference timing of the LCH allocation instruction by the calculated time difference. This transmission timing to PS determined based on the absolute reference of CS is herein referred to as a “normal transmission timing”.

The procedure proceeds from the control channel CCH to the traffic (information) channel TCH. PS sends a terminal-transmitted synchronous burst to CS. In receipt thereof, CS sends a base station-transmitted synchronous burst to PS at a given timing that is shifted arbitrarily from the normal transmission timing based on the above-described absolute reference timing.

By such modification of the transmission timing at CS, the succeeding reception and transmission timings at PS become shifted. More specifically, PS sends a terminal-transmitted idle burst to CS at a timing shifted from the normal timing, and in receipt of the burst, CS sends a base station-transmitted idle burst to PS while maintaining the shifted timing as above.

In a conventional transmission timing control method, when a new PS tries to connect with a CS, the CS side would always use normal transmission timings to process the control channel and the traffic channel for the PS. Consequently, the transmission timing from CS to PS would normally be fixed (to a leading section of each slot), and it was necessary to control in advance the transmission timings for users already connected to the relevant slot in conformity to that fixed timing.

By comparison, according to the control method of the present invention shown in FIG. 2, the CS side shifts the transmission timing for PS arbitrarily, which enables direct allocation of the transmission timing for a new user PS to an optimal transmission timing position within the slot. This eliminates the need to control in advance the transmission timings for already connected users within the relevant slot. Such arbitrary modification of the transmission timing for PS on the CS side is enabled by virtue of improvement in performance of PS, with enhanced tracking capability with respect to CS.

First Embodiment

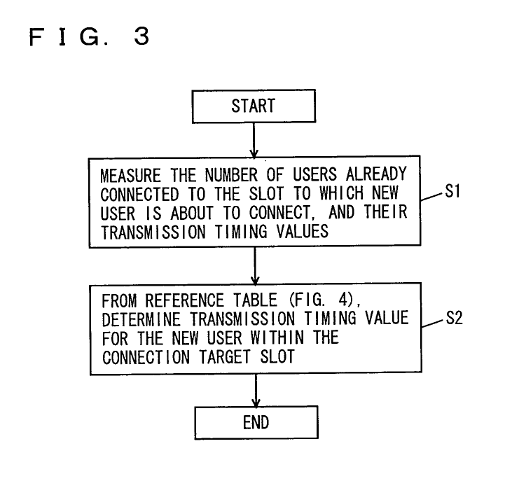

FIG. 3 is a flow chart illustrating fundamental processing of the transmission timing control method according to the first embodiment of the present invention. In the first embodiment described hereinbelow, upon a connection request from a new user to a slot, the transmission timing for any user already connected to the relevant slot is not shifted in advance. Rather, using the control procedure shown in FIG. 2, the transmission timing for the new user is shifted from the normal transmission timing to a currently optimal transmission timing position for allocation. That is, when there exist users already connected, the transmission timing for the new user is directly allocated to a transmission timing position that is the farthest from the transmission timing of the nearest one of the connected users.

Referring to FIG. 3, a basic operation of the transmission timing control method according to the first embodiment is explained. In FIG. 3, the following process steps S1 and S2 are carried out by DSP (transmission timing control unit 15b in FIG. 1) of the radio base station system.

Firstly, in step S1, the number of users already connected to a slot to which a new user is about to connect, and timing values representing transmission timing positions of the already connected users are measured.

Next, in step S2, based on the number of already connected users in the relevant slot and their transmission timing values measured in step S1, the transmission timing for the new user is allocated to an optimal transmission timing position defined in a reference table as will be described later. That is, the transmission timing value for the new user is determined.

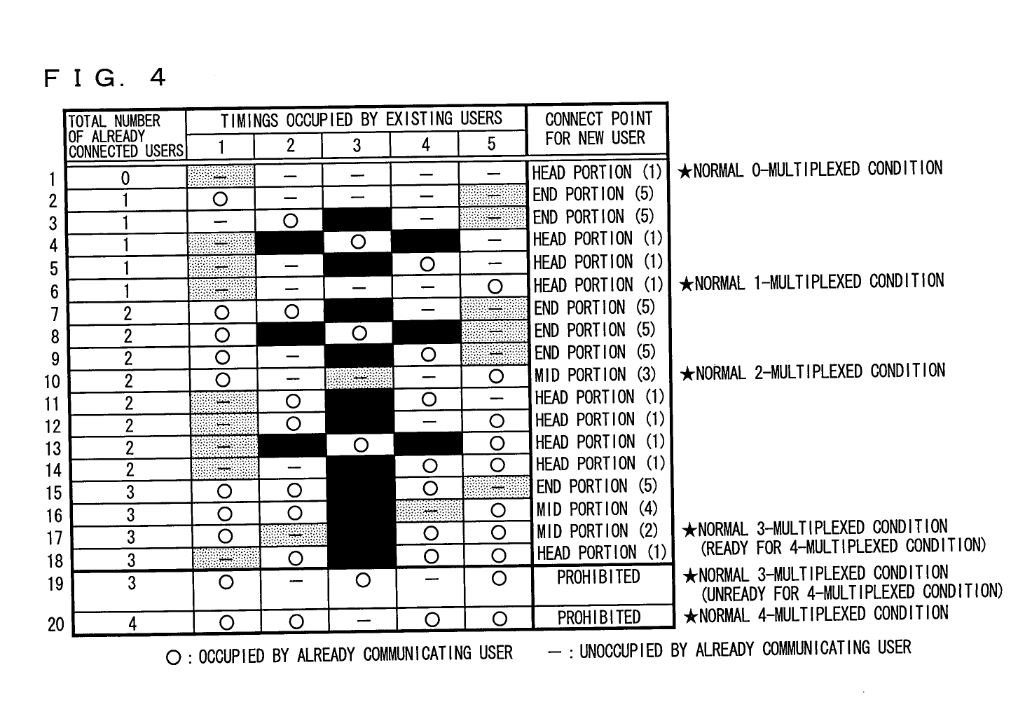

FIG. 4 shows an example of the reference table mentioned in step S2 of FIG. 3. FIG. 4 is a list of conditions where different numbers of users are already connected to one slot. The lateral direction corresponds to a time axis direction, and numerals 1-5 each show a position to which a transmission timing for PS can be allocated.

In practice, the intervals between the transmission timing positions 1-5 are uneven. The interval between positions 1 and 2, the interval between positions 2 and 4, and the interval between positions 4 and 5 are set equal to each other. It means that the intervals between positions 2 and 3 and between positions 3 and 4 are set shorter than the intervals between positions 1 and 2 and between positions 4 and 5. Accordingly, the transmission timing interval between the users allocated to neighboring positions 2, 3 or 3, 4 becomes especially short.

The number in each row in the vertical direction of the drawing represents the number of users already connected to a relevant slot. The circle at the transmission timing position in each row indicates presence of an already connected user, and the dash indicates absence of the already connected user. The blackened portions at positions 2, 3 and 4 indicate the timings where connection is prohibited from the beginning, because a transmission timing otherwise allocated thereto would become too close to the adjacent transmission timing position. The shadowed portions indicate the transmission timings to which a new user can be allocated.

More specifically, the first row indicates the case where there is no user already connected to the slot (O-multiplexed condition). The second through sixth rows indicate the case where there is one user already connected to the slot (1-multiplexed condition). The seventh through 14th rows indicate the case where two users are already connected to the slot (2-multiplexed condition). The 15th through 19th rows indicate the case where three users are already connected to the slot (3-multiplexed condition), and the 20th row indicates the case where there are four users already connected to the slot (4-multiplexed condition).

Processing to be carried out in each case of FIG. 4 upon issuance of a connection request from a new user is now described.

Firstly, the 0-multiplexed condition in the first row is a normal 0-multiplexed condition where the transmission timing for a user newly requesting a connection is allocated to a transmission timing position 1 at the head portion of the slot, as in the normal transmission timing.

In the 1-multiplexed condition in the second row, the transmission timing for the user newly requesting a connection is allocated to a transmission timing position 5 that is the farthest from the already connected user having been allocated to transmission timing position 1 at the head portion of the slot.

In the 1-multiplexed condition in the third row, the transmission timing to the user newly requesting a connection is allocated to transmission timing position 5 that is the farthest from the already connected user having been allocated to a transmission timing position 2 at the mid portion of the slot.

In the 1-multiplexed condition in the fourth row, the transmission timing to the user newly requesting a connection is allocated to transmission timing position 1 being the normal transmission timing position that is selected from the two possible transmission timing positions 1 and 5 equally the farthest from the already connected user having been allocated to a transmission timing position 3 at the mid portion of the slot.

In the 1-multiplexed condition in the fifth row, the transmission timing to the user newly requesting a connection is allocated to transmission timing position 1 that is the farthest from the already connected user having been allocated to a transmission timing position 4 at the mid portion of the slot.

In the 1-multiplexed condition in the sixth row, the transmission timing to the user newly requesting a connection is allocated to transmission timing position 1 that is the farthest from the already connected user having been allocated to transmission timing position 5 at the end portion of the slot. This multiplexed condition is a normal 1-multiplexed condition in that the new user is allocated to transmission timing position 1 at the head portion of the slot as in the normal transmission timing.

In the 2-multiplexed condition in the seventh row, the transmission timing to the user newly requesting a connection is allocated to transmission timing position 5 that is the farthest from the already connected user having been allocated to transmission timing position 2 at the mid portion of the slot.

In the 2-multiplexed condition in the eighth row, the transmission timing to the user newly requesting a connection is allocated to transmission timing position 5 that is the farthest from the already connected user having been allocated to transmission timing position 3 at the mid portion of the slot.

In the 2-multiplexed condition in the ninth row, the transmission timing to the user newly requesting a connection is allocated to transmission timing position 5 that is the farthest from the already connected user having been allocated to transmission timing position 4 at the mid portion of the slot.

In the 2-multiplexed condition in the tenth row, the transmission timing to the user newly requesting a connection is allocated to transmission timing position 3 that is the farthest from the already connected users having been allocated to transmission timing positions 1 and 5 at the head and end portions of the slot. This multiplexed condition is a normal 2-multiplexed condition in that the interval between the already connected users is maximized in advance.

In the 2-multiplexed condition in the 11th row, the transmission timing to the user newly requesting a connection is allocated to transmission timing position 1 as the normal transmission timing position that is selected from transmission timing positions 1 and 5 that are equally the farthest from the already connected users having been allocated to transmission timing positions 2 and 4 at the mid portion of the slot.

In the 2-multiplexed condition in the 12th row, the transmission timing to the user newly requesting a connection is allocated to transmission timing position 1 that is the farthest from the already connected user having been allocated to transmission timing position 2 at the mid portion of the slot.

In the 2-multiplexed condition in the 13th row, the transmission timing to the user newly requesting a connection is allocated to transmission timing position 1 that is the farthest from the already connected user having been allocated to transmission timing position 3 at the mid portion of the slot.

In the 2-multiplexed condition in the 14th row, the transmission timing to the user newly requesting a connection is allocated to transmission timing position 1 that is the farthest from the already connected user having been allocated to transmission timing position 4 at the mid portion of the slot.

In the 3-multiplexed condition in the 15th row, the transmission timing to the user newly requesting a connection is allocated to transmission timing position 5 that is the farthest from the already connected user having been allocated to transmission timing position 4 at the mid portion of the slot.

In the 3-multiplexed condition in the 16th row, the transmission timing to the user newly requesting a connection is allocated to transmission timing position 4 that is the farthest from the already connected user having been allocated to transmission timing position 5 at the end portion of the slot.

In the 3-multiplexed condition in the 17th row, the transmission timing to the user newly requesting a connection is allocated to transmission timing position 2 that is the farthest from the already connected user having been allocated to transmission timing position 1 at the head portion of the slot. This 3-multiplexed condition in the 17th row is particularly defined as a normal 3-multiplexed condition ready for the 4-multiplexed condition, under a predetermined condition in a predetermined manner, as will be described later.

In the 3-multiplexed condition in the 18th row, the transmission timing to the user newly requesting a connection is allocated to transmission timing position 1 that is the farthest from the already connected user having been allocated to transmission timing position 2 at the mid portion of the slot.

In the 3-multiplexed condition in the 19th row, only transmission timing positions 2 and 4 are available. In this case, allocation of the transmission timing for the user newly requesting a connection is prohibited, because, if it is allocated to either position 2 or 4, the distance from the user having been connected to transmission timing position 3 will be too small. This 3-multiplexed condition in the 19th row is specified as a normal 3-multiplexed condition unready for the 4-multiplexed condition, under a predetermined condition in a predetermined manner, as will be described later.

In the 4-multiplexed condition in the 20th row, only one transmission timing position 3 is available. In this case, again, allocation of the transmission timing for the user newly requesting a connection is prohibited, since the distances from the relevant position to the users having been connected to transmission timing positions 2 and 4 are too small.

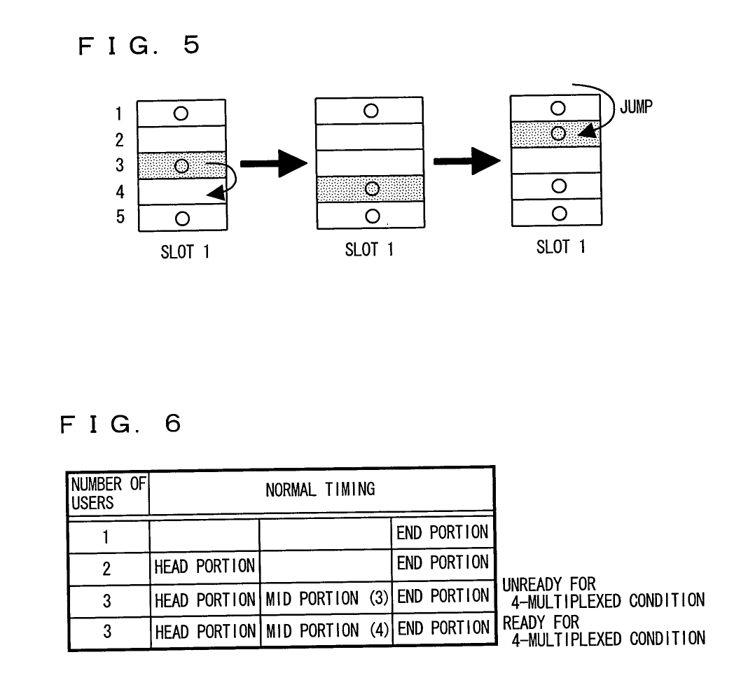

Now, the situation where a predetermined 4-multiplexed condition is ready in a 3-multiplexed condition as described in connection with the 17th row above is explained with reference to FIG. 5.

Generally, there is a low possibility that a new user is allocated to a slot of the 3-multiplexed condition, since the transmission timing for a new user is normally allocated to a slot having a low degree of path multiplexing. However, if a certain condition is satisfied due to an increase of the number of users connected to the whole three slots of traffic channel TCH, the transmission timing for the new user should inevitably be allocated to the slot of the 3-multiplexed condition.

Here, if the relevant 3-multiplexed condition is unready for a 4-multiplexed condition and connection of a new user is prohibited, as in the 19th row of FIG. 4, it should be made ready for the 4-multiplexed condition to allow the connection of the new user.

In FIG. 5, a rectangular frame representing a certain slot (e.g., slot 1) has a time axis direction in the vertical direction, and has transmission timing positions 1-5 from the top.

Firstly, as shown in the 19th row of FIG. 4, connection of a new user is prohibited as there are three users already connected to positions 1, 3 and 5 (see the slot on the left of FIG. 5). Thus, the transmission timing for the user at position 3 is moved to position 4 (see the slot at the center of FIG. 5). As a result, the normal 3-multiplexed condition ready for the 4-multiplexed condition as shown in the 17th row of FIG. 4 is realized, so that allocation of the new user to position 2 becomes possible (see the slot on the right of FIG. 5).

If the number of users connected to the whole three slots of TCH decreases and a certain condition is no longer fulfilled, then the prepared state for the 4-multiplexed condition in the 3-multiplexed condition is cancelled.

There is a case where the number of users having pass multiple connection to a specific slot decreases after connection of a new user, due to the reasons such as activation of interference, abnormal disconnection or the like. In the first embodiment of the present invention, when the number of users in a slot decreases, the transmission timings for the still connected users are shifted to realize a normal condition corresponding to the number of the users as shown in FIG. 6.

Specifically, the first row in FIG. 6 corresponds to the normal 1-multiplexed condition described above (the 6th row of FIG. 4), and the transmission timing for the already connected user is moved to position 5 at the end portion of the slot. The second row in FIG. 6 corresponds to the normal 2-multiplexed condition described above (the 10th row of FIG. 4), and the transmission timings for the two already connected users are moved to positions 1 and 5 at the head and end portions of the slot, respectively. The third row in FIG. 6 corresponds to the normal 3-multiplexed condition unready for the 4-multiplexed condition as described above (the 19th row of FIG. 4), and the transmission timings for the three already connected users are moved to position 1 at the head portion, position 3 at the mid portion and position 5 at the end portion of the slot. The fourth row in FIG. 6 corresponds to the normal 3-multiplexed condition ready for the 4-multiplexed condition as described above (the 17th row of FIG. 4), and the transmission timings for the three already connected users are moved to position 1 at the head portion, position 4 at the mid portion and position 5 at the end portion of the slot.

In terms of the order of movement of the already connected users, firstly the transmission timing for the first user is moved to position 5 at the end portion, the transmission timing for the second user is moved to position 1 at the head portion, and lastly, the transmission timing for the third user is moved to position 3 or 4 at the mid portion of the slot. Such movement of the already connected users to conform to the normal transmission timing can be carried out slowly on the basis of a prescribed time width for each frame.

As such, in the slot with a decreased number of users connected thereto, the distance between the transmission timings for the remaining users is maximized to prevent degradation of speech characteristics.

As described above, according to the first embodiment of the present invention, a new user about to connect to a slot is directly allocated to a currently optimal transmission timing in the slot, without moving in advance the transmission timings of users already connected to the relevant slot. Thus, there is no need to unnecessarily narrow the distance between the transmission timings of the already connected users, so that degradation of speech characteristics and interference between the users are prevented.

Further, when the number of users connected to a slot decreases, the distance between the transmission timings of the remaining users is maximized. Thus, it is possible to prevent degradation of speech characteristics and interference between the users even while waiting for a connection request from a new user.

Second Embodiment

There is a case where a user connected to a certain slot and in communication at its traffic channel TCH needs to switch the connection to another traffic channel TCH of another slot due to some reason during the communication. This is generally called TCH switching.

Such switching of traffic channels, when seen from a switching target slot, corresponds to a process of allocating a transmission timing position to a new user.

In the second embodiment of the present invention, when a user is about to connect to another slot for TCH switching, the transmission timing of the base station-transmitted synchronous burst is shifted from the transmission timing in the slot before switching, as in the control procedure shown in FIG. 2, so that the user can be directly allocated to a currently optimal transmission timing position in the switching target slot, without moving in advance the transmission timings for users already connected to the relevant slot.

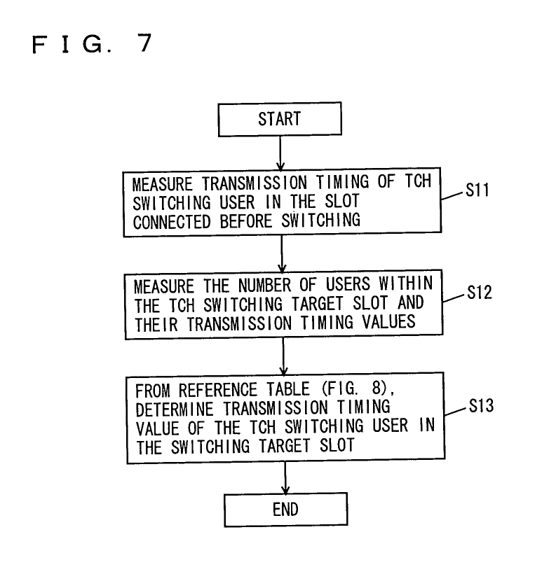

FIG. 7 is a flow chart illustrating fundamental processing of the transmission timing control method according to the second embodiment of the present invention.

Referring to FIG. 7, a basic operation of the transmission timing control method according to the second embodiment is described. In FIG. 7, the process steps S11, S12 and S13 explained below are carried out by DSP (transmission timing control unit 15b in FIG. 1) of the radio base station system.

Firstly, in step S11, for a user attempting TCH switching, or a TCH switching user, the transmission timing in a slot connected before switching is measured.

Next, in step S12, the number of users already connected to a switching target slot to which the TCH switching user is about to connect, and timing values representing the transmission timings for the already connected users are measured.

Next, in step S13, based on the number of the users already connected to the switching target slot and their transmission timing values measured in step S12, the transmission timing for the TCH switching user is allocated in the switching target slot to an optimal transmission timing position defined in a reference table as will be described later. That is, the transmission timing value of the TCH switching user is determined.

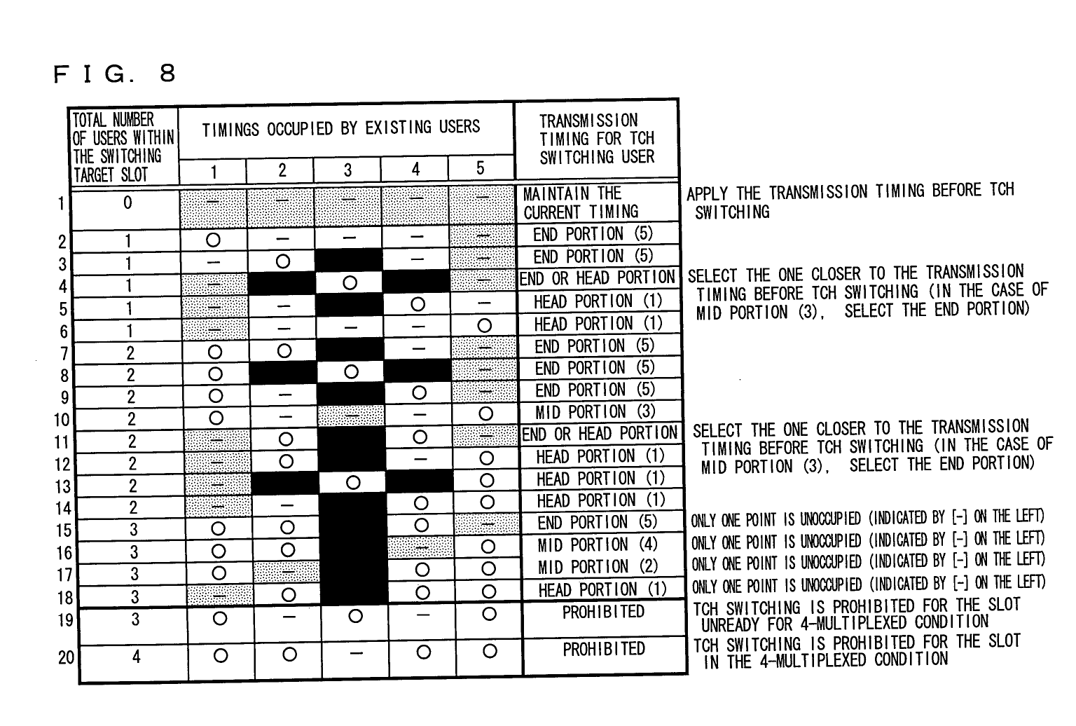

FIG. 8 shows an example of the reference table mentioned in step S13 of FIG. 7. As is the case of FIG. 4 above, FIG. 8 is a list of conditions where different numbers of users are already connected to one slot.

Connection to another slot by the TCH switching corresponds to connection of a new user when seen from the relevant slot. Thus, the process in step S13 of FIG. 7 based on the table of FIG. 8 is basically the same as the process in step S2 of FIG. 3 based on the table of FIG. 4, except for the following points.

That is, in the first embodiment of FIG. 4, in the case of the first row where there is no user previously connected to the slot, the transmission timing for the new user has been allocated to the transmission timing position 1 at the head portion of the slot, as in the normal transmission timing for the new user. By comparison, in the second embodiment of FIG. 8, in the first row with no user already connected to the slot, the transmission timing before the TCH switching measured in step S11 of FIG. 7 is maintained, and the new user is allocated to the corresponding transmission timing position in the slot.

Further, in the first embodiment of FIG. 4, in the case of the fourth and 11th rows where there are two transmission timing positions (position 1 and position 5) that are equally the farthest from the already connected user, the transmission timing for the new user has been allocated to the transmission timing position 1 at the head portion of the slot, as in the normal transmission timing for the new user. By comparison, in the second embodiment of FIG. 8, in the fourth and 11th rows, the transmission timing that is closer to the transmission timing before the TCH switching having been measured in step S11 of FIG. 7 is selected, and the new user is allocated to the relevant transmission timing position of the slot.

Otherwise, the processes in the first embodiment and in the second embodiment are basically identical to each other, so that description of the other processes in the second embodiment is not repeated here.

As described above, according to the second embodiment of the present invention, a user attempting TCH switching, or a TCH switching user, about to connect to a new slot is directly allocated to a currently optimal transmission timing in the relevant slot, without moving in advance the transmission timings for users already connected to the slot. Thus, there is no need to unnecessarily narrow the transmission timing interval of the already connected users, and therefore, degradation of speech characteristics and interference between the users are prevented.

The first and second embodiments have been described above both taking as an example the 4-multiplexed system permitting at most four users to establish path division multiple connection with one slot. However, not limited to such a 4-multiplexed system, the present invention is applicable to other multiplexed systems such as a 3-multiplexed system and a 2-multiplexed system.

In the case of the 4-multiplexed system, the intervals between the respective transmission timing positions 1-5 are uneven as described above. Specifically, the transmission timing positions are set such that the intervals between positions 1 and 2, between positions 2 and 4, and between positions 4 and 5 become equal to each other, or, a section within a slot in which transmission timings can be shifted is divided into three equal parts.

By comparison, for example in the 3-multiplexed system, users are allowed to establish path multiple connection with three transmission timing positions within a slot corresponding to transmission timing positions 1, 3 and 5 in the 4-multiplexed system. The interval between positions 1 and 3 and the interval between positions 3 and 5 are set equal to each other. That is, the transmission timing shiftable section within a slot is divided into two equal parts.

In such a 3-multiplexed system, when two users have already been connected to a slot, the transmission timings of the users may be moved to the head and end portions of the slot to maximize the transmission timing interval between the relevant users. This prevents degradation of speech characteristics and interference between the users even while waiting for a connection request from a new user.

The transmission timing position at the mid portion of the slot is then allocated to such a user newly requesting a connection. As such, the advantage that a new user about to connect to a certain slot is shifted and directly allocated to an optimal transmission timing within the slot is enjoyed also in the case of the 3-multiplexed system, as in the 4-multiplexed system in the foregoing first and second embodiments.

As described above, according to the present invention, when a new user or a TCH switching user is about to connect to a certain slot, the transmission timing for the new user or the TCH switching user can be shifted from a normal transmission timing or a timing before the TCH switching and directly allocated to an optimal transmission timing position in the relevant slot. Thus, it becomes unnecessary to narrow in advance the transmission timing interval between users already connected to the same time slot, and degradation of speech characteristics and interference between the users are prevented.

### INDUSTRIAL APPLICABILITY

The present invention is effective in a radio base station system permitting a plurality of users to establish path division multiple connection, as it allows connection of a new user without degradation of speech characteristics or interference between users.

1. A radio base station system permitting path multiple connection of a plurality of mobile terminal devices and transmitting/receiving signals to/from said plurality of mobile terminal devices in units of a plurality of slots, comprising:
measuring means (14) for measuring the number of other mobile terminal devices previously connected to one of said plurality of slots to which a new mobile terminal device is about to connect, and transmission timing positions for said other mobile terminal devices within said slot; and
transmission timing control means (14), when a result of measurement of said measuring means shows that there is not any other mobile terminal device connected to said slot, for allocating a transmission timing for said new mobile terminal device to a leading timing position in said slot, and, when the result shows that there is at least one said other mobile terminal device already connected to said slot, for allocating the transmission timing for said new mobile terminal device to a transmission timing position that is the farthest from the transmission timing position for said connected other mobile terminal device, without moving the transmission timing position for said connected other mobile terminal device.

2. The radio base station system according to claim 1, wherein when there are a plurality of transmission timing positions that are the farthest from the transmission timing position for said connected other mobile terminal device, said transmission timing control means allocates the transmission timing for said new mobile terminal device to the transmission timing position that is the closest to the leading timing position, among said plurality of transmission timing positions.

3. The radio base station system according to claim 1, wherein in the case where the total number of the mobile terminal devices connected to said plurality of slots satisfies a predetermined condition, said transmission timing control means moves in advance the transmission timing position for said other mobile terminal device to secure a timing position to be allocated to the transmission timing for said new mobile terminal device when the number of the other mobile terminal devices connected to said slot is a first predetermined number, and prohibits connection of said new mobile terminal device when said predetermined condition is unsatisfied, with the timing position to be allocated to the transmission timing for said new mobile terminal device being unsecured.

4. The radio base station system according to claim 1, wherein said transmission timing control means prohibits connection of said new mobile terminal device when the number of the other mobile terminal devices connected to said slot is a second predetermined number.

5. The radio base station system according to claim 1, wherein when any of the mobile terminal devices connected to said slot is disconnected, said transmission timing control means controls the transmission timing for the mobile terminal device still connected to said slot such that the transmission timing for said remaining mobile terminal device is moved to a predetermined transmission timing position.

6. The radio base station system according to claim 1, wherein said transmission timing control means moves a transmission timing of a synchronous burst transmitted to said new mobile terminal device during processing of a traffic channel, thereby moving the transmission timing for said new mobile terminal device.

7. A radio base station system permitting path multiple connection of a plurality of mobile terminal devices and transmitting/receiving signals to/from said plurality of mobile terminal devices in units of a plurality of slots, comprising:
first measuring means (14) for measuring, for a mobile terminal device attempting to switch a traffic channel, a transmission timing position in a slot to which the mobile terminal device has been connected before the switching;
second measuring means (14) for measuring, for the one of said plurality of slots to which the mobile terminal device attempting to switch the traffic channel is about to connect, the number of other mobile terminal devices previously connected to said slot and transmission timing positions for said other mobile terminal devices in said slot; and
transmission timing control means (14), when a result of measurement of said second measuring means shows that there is not any other mobile terminal device connected to said slot, for allocating a transmission timing for said mobile terminal device attempting to switch the traffic channel to a transmission timing position within said slot that corresponds to the transmission timing position in the slot to which said mobile terminal device has been connected before said switching measured by said first measuring means, and, when there is at least one said other mobile terminal device already connected to said slot, for allocating the transmission timing for said mobile terminal device attempting to switch the traffic channel to a transmission timing position that is the farthest from the transmission timing position for said connected other mobile terminal device, without moving the transmission timing position for said connected other mobile terminal device.

8. The radio base station system according to claim 7, wherein when there are a plurality of transmission timing positions that are the farthest from the transmission timing position for said connected other mobile terminal device, said transmission timing control means allocates the transmission timing for said mobile terminal device attempting to switch the traffic channel to the transmission timing position that is the closest to the transmission timing position in the slot to which said mobile terminal device has been connected before said switching, among said plurality of transmission timing positions.

9. The radio base station system according to claim 7, wherein in the case where the total number of the mobile terminal devices connected to said plurality of slots satisfies a predetermined condition, when the number of the other mobile terminal devices connected to said slot is a first predetermined number, said transmission timing control means moves in advance the transmission timing position for said other mobile terminal device to secure a timing position to be allocated to the transmission timing for said mobile terminal device attempting to switch the traffic channel, and, when said predetermined condition is unsatisfied with the timing position to be allocated to the transmission timing for said mobile terminal device attempting to switch the traffic channel being unsecured, prohibits connection of said mobile terminal device attempting to switch the traffic channel.

10. The radio base station system according to claim 7, wherein when the number of the other mobile terminal devices connected to said slot is a second predetermined number, said transmission timing control means prohibits connection of said mobile terminal device attempting to switch the traffic channel.

11. The radio base station system according to claim 7, wherein when any of the mobile terminal devices connected to said slot is disconnected, said transmission timing control means controls the transmission timing for the mobile terminal device still connected to said slot such that the transmission timing for said remaining mobile terminal device is moved to a predetermined transmission timing position.

12. The radio base station system according to claim 7, wherein said transmission timing control means moves a transmission timing of a synchronous burst transmitted to said mobile terminal device attempting to switch the traffic channel during processing of a traffic channel, thereby moving the transmission timing for said mobile terminal device attempting to switch the traffic channel.

13. A transmission timing control method in a radio base station system permitting path multiple connection of a plurality of mobile terminal devices and transmitting/receiving signals to/from said plurality of mobile terminal devices in units of a plurality of slots, comprising the steps of:
measuring the number of other mobile terminal devices previously connected to one of said plurality of slots to which a new mobile terminal device is about to connect, and transmission timing positions for said other mobile terminal devices within said slot; and
as a result of measurement of said measuring step, when there is not any other mobile terminal device connected to said slot, allocating a transmission timing for said new mobile terminal device to a leading timing position in said slot, and, when there is at least one said other mobile terminal device already connected to said slot, allocating the transmission timing for said new mobile terminal device to a transmission timing position that is the farthest from a transmission timing position for said connected other mobile terminal device, without moving the transmission timing position for said connected other mobile terminal device.

14. The transmission timing control method according to claim 13, wherein when there are a plurality of transmission timing positions that are the farthest from the transmission timing position for said connected other mobile terminal device, said step of controlling the transmission timing includes the step of allocating the transmission timing for said new mobile terminal device to the transmission timing position that is the closest to the leading timing position, among said plurality of transmission timing positions.

15. The transmission timing control method according to claim 13, wherein in the case where the total number of the mobile terminal devices connected to said plurality of slots satisfies a predetermined condition, said step of controlling the transmission timing includes the step of moving the transmission timing position for said other mobile terminal device in advance to secure a timing position to be allocated to the transmission timing for said new mobile terminal device when the number of the other mobile terminal devices connected to said slot is a first predetermined number, and prohibiting connection of said new mobile terminal device when said predetermined condition is unsatisfied, with the timing position to be allocated to the transmission timing for said new mobile terminal device being unsecured.

16. The transmission timing control method according to claim 13, wherein said step of controlling the transmission timing includes the step of prohibiting connection of said new mobile terminal device when the number of the other mobile terminal devices connected to said slot is a second predetermined number.

17. The transmission timing control method according to claim 13, wherein said step of controlling the transmission timing includes the step of, when any of the mobile terminal devices connected to said slot is disconnected, controlling the transmission timing for the mobile terminal device still connected to said slot such that the transmission timing for said remaining mobile terminal device is moved to a predetermined transmission timing position.

18. The transmission timing control method according to claim 13, wherein said step of controlling the transmission timing includes the step of moving a transmission timing of a synchronous burst transmitted to said new mobile terminal device during processing of a traffic channel to thereby move the transmission timing for said new mobile terminal device.

19. A transmission timing control method in a radio base station system permitting path multiple connection of a plurality of mobile terminal devices and transmitting/receiving signals to/from said plurality of mobile terminal devices in units of a plurality of slots, comprising the steps of:
measuring, for a mobile terminal device attempting to switch a traffic channel, a transmission timing position in a slot to which the mobile terminal device has been connected before the switching;
measuring, for one of said plurality of slots to which said mobile terminal device attempting to switch the traffic channel is about to connect, the number of other mobile terminal devices previously connected to said slot and transmission timing positions for said other mobile terminal devices in said slot; and
as a result of said measurement, when there is not any other mobile terminal device connected to said slot, allocating a transmission timing for said mobile terminal device attempting to switch the traffic channel to a transmission timing position within said slot that corresponds to said measured transmission timing position in the slot to which said mobile terminal device has been connected before the switching, and, when there is at least one said other mobile terminal device already connected to said slot, allocating the transmission timing for said mobile terminal device attempting to switch the traffic channel to a transmission timing position that is the farthest from the transmission timing position for said connected other mobile terminal device, without moving the transmission timing position for said connected other mobile terminal device.

20. The transmission timing control method according to claim 19, wherein when there are a plurality of transmission timing positions that are the farthest from the transmission timing position for said connected other mobile terminal device, said step of controlling the transmission timing includes the step of allocating the transmission timing for said mobile terminal device attempting to switch the traffic channel to the transmission timing position that is the closest to the transmission timing position in the slot to which said mobile terminal device has been connected before the switching, among said plurality of transmission timing positions.

21. The transmission timing control method according to claim 19, wherein in the case where the total number of the mobile terminal devices connected to said plurality of slots satisfies a predetermined condition, said step of controlling the transmission timing includes the step of, when the number of the other mobile terminal devices connected to said slot is a first predetermined number, moving the transmission timing position for said other mobile terminal device in advance to secure a transmission timing position to be allocated to the transmission timing for said mobile terminal device attempting to switch the traffic channel, and, when said predetermined condition is unsatisfied, with the transmission timing position to be allocated to the transmission timing for said mobile terminal device attempting to switch the traffic channel being unsecured, prohibiting connection of said mobile terminal device attempting to switch the traffic channel.

22. The transmission timing control method according to claim 19, wherein said step of controlling the transmission timing includes the step of prohibiting connection of said mobile terminal device attempting to switch the traffic channel when the number of the other mobile terminal devices connected to said slot is a second predetermined number.

23. The transmission timing control method according to claim 19, wherein said step of controlling the transmission timing includes the step of, when any of the mobile terminal devices connected to said slot is disconnected, controlling the transmission timing for the mobile terminal device still connected to said slot such that the transmission timing for said remaining mobile terminal device is moved to a predetermined transmission timing position.

24. The transmission timing control method according to claim 19, wherein said step of controlling the transmission timing includes the step of moving a transmission timing of a synchronous burst transmitted to said mobile terminal device attempting to switch the traffic channel during processing of a traffic channel, thereby moving the transmission timing for said mobile terminal device attempting to switch the traffic channel.

25. A transmission timing control program in a radio base station system permitting path multiple connection of a plurality of mobile terminal devices and transmitting/receiving signals to/from said plurality of mobile terminal devices in units of a plurality of slots, making a computer carry out the steps of:
measuring the number of other mobile terminal devices previously connected to one of said plurality of slots to which a new mobile terminal device is about to connect, and transmission timing positions for said other mobile terminal devices within said slot; and
as a result of measurement of said measuring step, when there is not any other mobile terminal device connected to said slot, allocating a transmission timing for said new mobile terminal device to a leading timing position in said slot, and, when there is at least one said other mobile terminal device already connected to said slot, allocating the transmission timing for said new mobile terminal device to a transmission timing position that is the farthest from a transmission timing position for said connected other mobile terminal device, without moving the transmission timing position for said connected other mobile terminal device.

26. The transmission timing control program according to claim 25, wherein when there are a plurality of transmission timing positions that are the farthest from the transmission timing position for said connected other mobile terminal device, said step of controlling the transmission timing includes the step of allocating the transmission timing for said new mobile terminal device to the transmission timing position that is the closest to the leading timing position, among said plurality of transmission timing positions.

27. The transmission timing control program according to claim 25, wherein in the case where the total number of the mobile terminal devices connected to said plurality of slots satisfies a predetermined condition, said step of controlling the transmission timing includes the step of moving the transmission timing position for said other mobile terminal device in advance to secure a timing position to be allocated to the transmission timing for said new mobile terminal device when the number of the other mobile terminal devices connected to said slot is a first predetermined number, and prohibiting connection of said new mobile terminal device when said predetermined condition is unsatisfied, with the timing position to be allocated to the transmission timing for said new mobile terminal device being unsecured.

28. The transmission timing control program according to claim 25, wherein said step of controlling the transmission timing includes the step of prohibiting connection of said new mobile terminal device when the number of the other mobile terminal devices connected to said slot is a second predetermined number.

29. The transmission timing control program according to claim 25, wherein said step of controlling the transmission timing includes the step of, when any of the mobile terminal devices connected to said slot is disconnected, controlling the transmission timing for the mobile terminal device still connected to said slot such that the transmission timing for said remaining mobile terminal device is moved to a predetermined transmission timing position.

30. The transmission timing control program according to claim 25, wherein said step of controlling the transmission timing includes the step of moving a transmission timing of a synchronous burst transmitted to said new mobile terminal device during processing of a traffic channel to thereby move the transmission timing for said new mobile terminal device.

31. A transmission timing control program in a radio base station system permitting path multiple connection of a plurality of mobile terminal devices and transmitting/receiving signals to/from said plurality of mobile terminal devices in units of a plurality of slots, making a computer carry out the steps of:
measuring, for a mobile terminal device attempting to switch a traffic channel, a transmission timing position in a slot to which the mobile terminal device has been connected before the switching;
measuring, for one of said plurality of slots to which said mobile terminal device attempting to switch the traffic channel is about to connect, the number of other mobile terminal devices previously connected to said slot and transmission timing positions for said other mobile terminal devices in said slot; and
as a result of said measurement, when there is not any other mobile terminal device connected to said slot, allocating a transmission timing for said mobile terminal device attempting to switch the traffic channel to a transmission timing position within said slot that corresponds to said measured transmission timing position in the slot to which said mobile terminal device has been connected before the switching, and, when there is at least one said other mobile terminal device already connected to said slot, allocating the transmission timing for said mobile terminal device attempting to switch the traffic channel to a transmission timing position that is the farthest from the transmission timing position for said connected other mobile terminal device, without moving the transmission timing position for said connected other mobile terminal device.

32. The transmission timing control program according to claim 31, wherein when there are a plurality of transmission timing positions that are the farthest from the transmission timing position for said connected other mobile terminal device, said step of controlling the transmission timing includes the step of allocating the transmission timing for said mobile terminal device attempting to switch the traffic channel to the transmission timing position that is the closest to the transmission timing position in the slot to which said mobile terminal device has been connected before the switching, among said plurality of transmission timing positions.

33. The transmission timing control program according to claim 31, wherein in the case where the total number of the mobile terminal devices connected to said plurality of slots satisfies a predetermined condition, said step of controlling the transmission timing includes the step of, when the number of the other mobile terminal devices connected to said slot is a first predetermined number, moving the transmission timing position for said other mobile terminal device in advance to secure a transmission timing position to be allocated to the transmission timing for said mobile terminal device attempting to switch the traffic channel, and, when said predetermined condition is unsatisfied, with the transmission timing position to be allocated to the transmission timing for said mobile terminal device attempting to switch the traffic channel being unsecured, prohibiting connection of said mobile terminal device attempting to switch the traffic channel.

34. The transmission timing control program according to claim 31, wherein said step of controlling the transmission timing includes the step of prohibiting connection of said mobile terminal device attempting to switch the traffic channel when the number of the other mobile terminal devices connected to said slot is a second predetermined number.

35. The transmission timing control program according to claim 31, wherein said step of controlling the transmission timing includes the step of, when any of the mobile terminal devices connected to said slot is disconnected, controlling the transmission timing for the mobile terminal device still connected to said slot such that the transmission timing for said remaining mobile terminal device is moved to a predetermined transmission timing position.

36. The transmission timing control program according to claim 31, wherein said step of controlling the transmission timing includes the step of moving a transmission timing of a synchronous burst transmitted to said mobile terminal device attempting to switch the traffic channel during processing of a traffic channel, thereby moving the transmission timing for said mobile terminal device attempting to switch the traffic channel.
